(19) United States
(12) Patent Application Publication
(10) Pub. No.: US 2024/0420017 A1
(43) Pub. Date: Dec. 19, 2024

(54) Improved Training Set Selection for Semi-Supervised Learning

(71) Applicant: ServiceNow, Inc., Santa Clara, CA (US)

(72) Inventors: Issam Hadj Laradji, Vancouver (CA); Nicholas Botzer, Santa Clara, CA (US); David Vazquez, Montreal (CA)

(21) Appl. No.: 18/336,511

(22) Filed: Jun. 16, 2023

(51) Int. Cl. G06N 20/00

(52) U.S. Cl. CPC G06N 20/00

(57) ABSTRACT

Improved methods for semi-supervised training are provided. These methods include using a model that has been trained used ground-truth labeled training examples to predict the class of a set of unlabeled training examples. A subset of the unlabeled training examples are then added to the labeled training dataset, labeled with the model-generated labels. The added subset are balanced across the predicted classes (e.g., an equal number added from each predicted class) in order to reduce bias in the augmented training dataset toward representation of ‘easy’ classes. Confidence scores used to select which training examples to add from each predicted class could be based on a confidence output of the model. Additionally or alternatively, the confidence scores could be determined based on distance, in an embedding space of the model, between the unlabeled training examples and labeled training examples whose class label match the predicted label of the unlabeled training examples.

### BACKGROUND

To train a machine learning model, a great deal of training data is often needed. While unlabeled data may be relatively easy to acquire, ‘ground truth’ labels for such data (e.g., labels indicating the sentiment represented by human-generated text or speech) can be difficult to acquire.

### SUMMARY

Semi-supervised training systems may be employed to use a relatively small set of labeled training examples to ‘bootstrap’ the generation of additional labeled training examples from a large set of unlabeled training examples. In some semi-supervised training systems, a small set of labeled examples is used to initially train a model, and the trained model is used to label unlabeled examples. The labeled examples are added to the training dataset and used to further train the model, with the process repeating.

Semi-supervised training methods can be employed to leverage a relatively small set of labeled training data to provide labels for a larger set of unlabeled training data. This can include using the set of labeled training data to train an initial model to predict the labels, and then applying the initial model to generate labels for the unlabeled training data. Some or all of the now-labeled training data can then be added to the set of labeled training data, and this augmented training dataset used to further train the model. Such a process of model generation of labels for unlabeled training data, addition of the now-labeled training data to the existing labeled training dataset, and use of the expanded training dataset to further train the model can be performed iteratively a number of times to result in an improved model using a relatively small number of initial human-labeled or otherwise rare labeled training examples, with the number of examples in the labeled training dataset expanding with each iteration as model-labeled training examples are added thereto.

In order to provide accurate labeled examples from the unlabeled dataset to the training dataset, unlabeled examples associated with respective confidence levels above a threshold, that have the highest confidence levels of the unlabeled examples, or that otherwise exhibit elevated confidence may be added to the training dataset. However, this may bias the training dataset towards ‘easy’ classes (whose labels are higher-confidence), while under-representing the ‘difficult’ classes. This has the effect of over-fitting the model for the ‘easy’ classes, while the ‘hard’ classes remain hard, due to under-representation in the training dataset.

The embodiments provided herein address this issue by ‘balancing’ the selection of examples to add to the training dataset across the predicted classes. For example, the top five examples with “Label 1”, the top five examples with “Label 2,” etc. with respect to confidence level may all be added, so that the set of added training examples is not biased toward any particular class(es) (e.g., toward classes that the model already performs well on). In such an example, the confidence for the top 5 selected from an ‘easy’ class may be much higher than the confidence for the top 5 from the ‘hard’ class. Such a class-balanced selection of training example can be a strictly uniformly balanced (the same number of examples from each class) or some other variety of balancing (e.g., the top 5 from each class, and then another 10 of the top-scoring example without regard to class).

Embodiments described herein also include augmenting a model-generated label confidence score by including (e.g., in weighted or other combination with a model-output confidence value) distance-based information about the unlabeled training examples in an embedding space relative to already-labeled training examples. In some examples the model generates, either as an output or as an intermediate product, an embedding vector that represents an input training example in an embedding space (e.g., a paragraph vector that represents an input text in a semantically-encoded embedding space). In such examples, embedding vectors can be determined for the already-labeled training examples and for the unlabeled training examples. Distances in the embedding space (e.g., cosine similarities) between the unlabeled examples and labeled examples of the same predicted class could then be determined and used to score the confidence of the unlabeled examples, such that unlabeled examples that are closer in the embedding space to labeled examples are scored with higher confidence. This could be an indication that the unlabeled training examples, being closer in the embedding space to same-class labeled examples, are more likely to be accurately labeled by the model.

Models trained in this manner could be applied in a variety of applications wherein an available set of labeled training examples is relatively small, but where there is also a comparatively larger set of available unlabeled training examples. For example, models and model training methods as described herein could be employed to predict the sentiment or ‘type’ of a textual response, using a large corpus of unlabeled textual training data made available as a result of stored user interactions with virtual and/or human agents (e.g., via a support website, app or other communications channel).

Accordingly, a first example embodiment may involve (i) obtaining a first set of training data that includes a first plurality of training examples; (ii) obtaining a machine learning model that has been trained to select, from a set of classes, a predicted class for an input; (iii) applying each training example of the first set of training data to the machine learning model to (a) predict a respective class from the set of classes and (b) determine a respective score that is representative of a degree of confidence of the respective class; (iv) selecting, from the first set of training data, a subset of training examples by selecting at least a top N training examples, with respect to score, from each of the predicted classes of the set of classes; (v) generating a second set of training data that includes the subset of training examples selected from the first set of training data, wherein each training example of the subset is labelled in the second set of training data as belonging to a respective class as predicted by the machine learning model; and (vi) using the second set of training data, further training the machine learning model, thereby generating an updated machine learning model.

A second example embodiment may involve a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts the locations of instances of training data projected into an embedding space, in accordance with example embodiments.

FIG. 6B depicts the locations of instances of training data projected into an embedding space, in accordance with example embodiments.

FIG. 6C depicts the locations of instances of training data projected into an embedding space, in accordance with example embodiments.

FIG. 7 depicts the locations of instances of training data projected into an embedding space, in accordance with example embodiments.

FIG. 8 depicts experimental results, in accordance with example embodiments.

FIG. 9 depicts experimental results, in accordance with example embodiments.

FIG. 10 depicts experimental results, in accordance with example embodiments.

FIG. 11 depicts experimental results, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

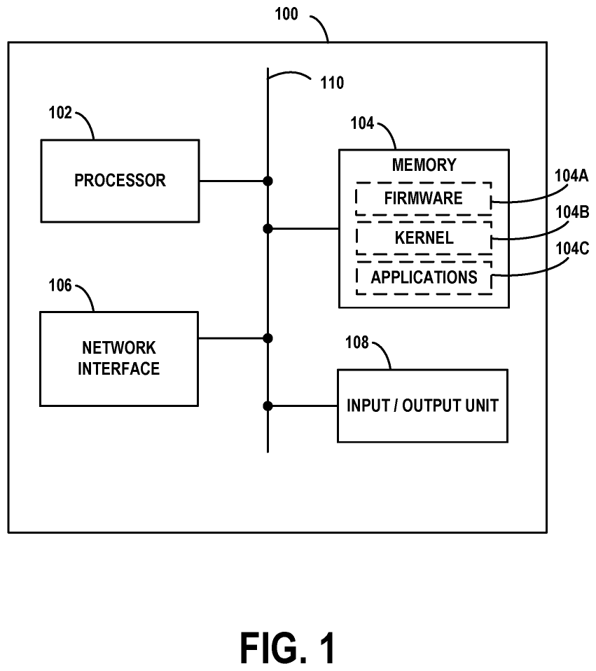

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

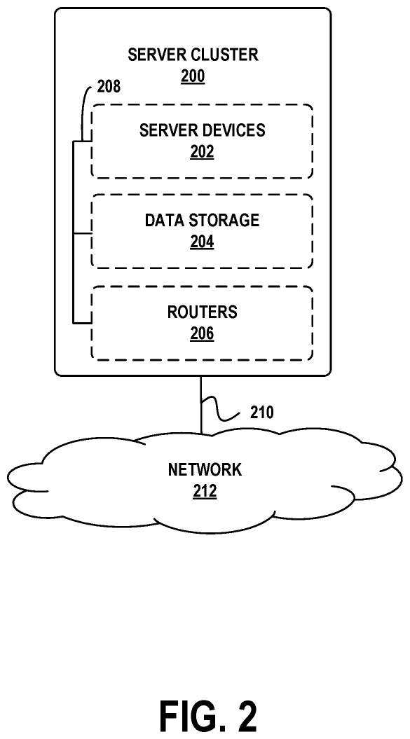

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

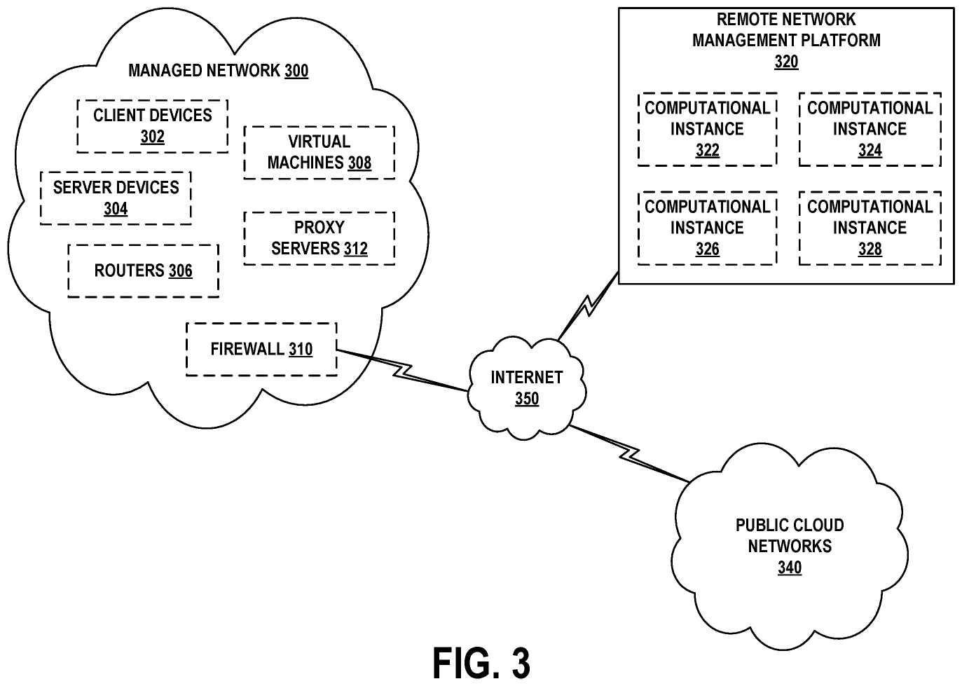

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

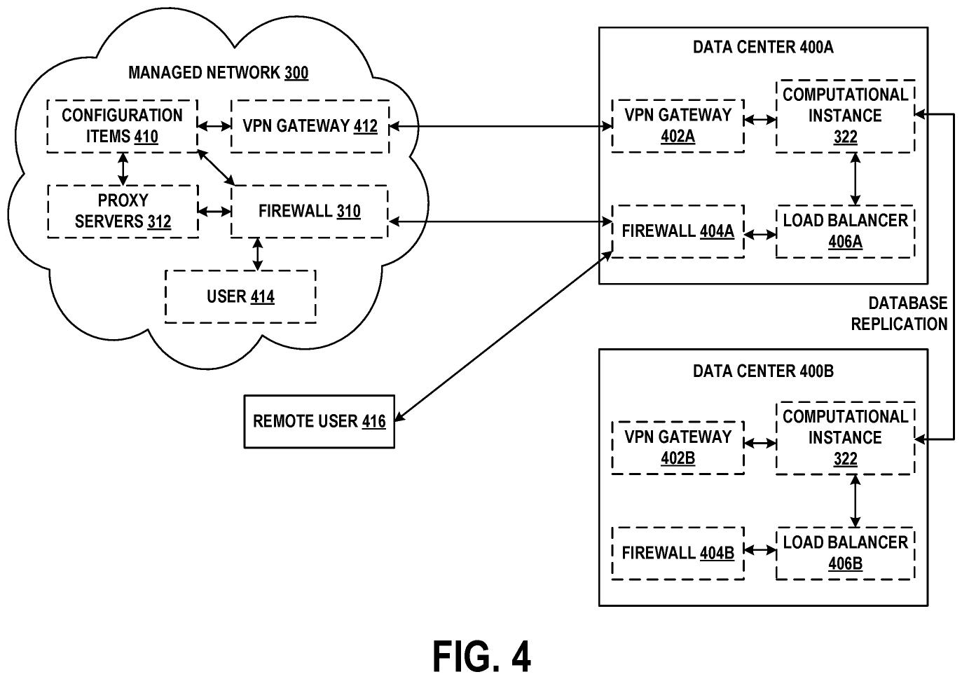

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

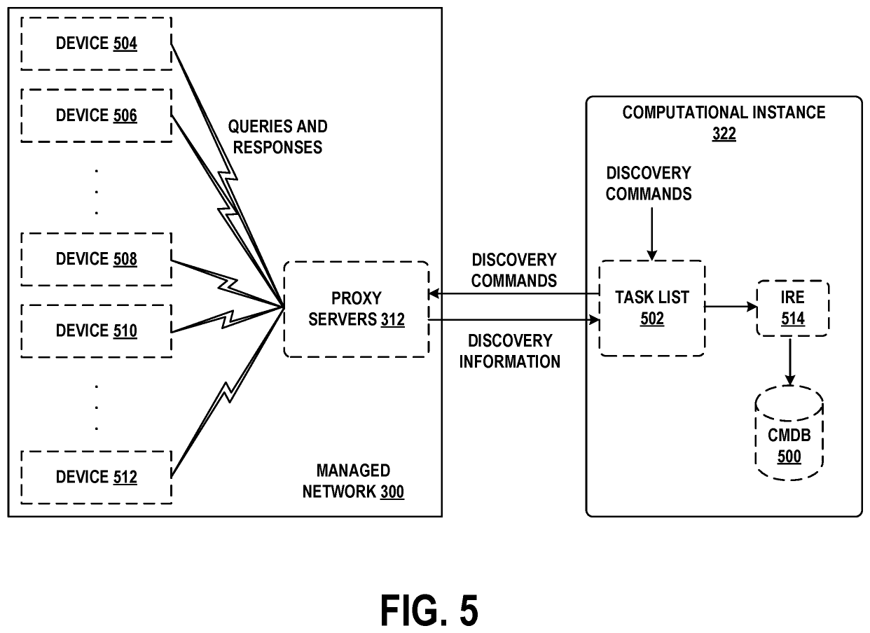

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Example Training Dataset Generation and Expansion

As noted above, it is desirable to leverage available training data to train models to accurately classify novel inputs or to otherwise generate outputs from novel inputs (e.g., to generate representative vectors in a semantically-encoded embedding space). For example, it is desirable to be able to predict a sentiment or some other representative label for the content of textual information like user statements or queries in a virtual agent dialog or other communications channel. However, in many cases the number of examples of training data that is labeled (and that can thus be used directly to train such a model) may be greatly outnumbered by the examples of training that are not labeled. This may be due to the labeling process being expensive, requiring extensive human time or effort to generate (e.g., by a human labeler assigning labels to the training examples), or due to some other factor making it difficult to obtain labels for relatively numerous available training data examples.

To address this issue, semi-supervised training techniques may be employed. These techniques may leverage the relatively fewer labeled training data examples to generate labels for some (or all) of the unlabeled training data examples. These model-labeled examples can then be added to the labeled examples in the training dataset and used to train a model to predict labels for novel input. Such a method can proceed iteratively, adding only a subset of the unlabeled examples, with their corresponding model-generated labels, to the training dataset at a time. The expanded training dataset can then be used to further train the model, which is then used to generate labels for additional unlabeled training data examples, which can then be added to the training dataset, etc.

Such a semi-supervised method can allow a relatively small number of labeled training examples to be ‘bootstrapped’ into a much larger training dataset where a large number of unlabeled training examples are also available. However, the benefits of such a method depend on the accuracy of the model-generated labels for those unlabeled training examples that are added to the training dataset, as well as the representation of the various label classifications amongst the added training examples. It is desirable to only add those training examples for which there is a high ‘confidence’ in the model-generated labels. However, it is also desirable to represent all of the possible label classes (e.g., to an equal degree) in the growing set of training examples. If only the highest-confidence unlabeled training examples are added, without consideration of the under- or over-representation of the various possible classes in this highest-confidence set, then the expanded training dataset may become biased toward ‘easy’ classes (that is, classes that the model being trained is already proficient at labeling with high confidence), with relatively ‘harder’ classes under-represented. This can lead the model to becoming even more proficient at predicting the ‘easy’ class(es) and even worse at predicting the ‘hard’ class(es).

To ameliorate these issues, the unlabeled training examples selected for addition to the labeled training dataset can be balanced with respect to the predicted classes of the unlabeled training examples. For example, where at least 40 unlabeled training examples are to be added to the training dataset and there are 8 potential classes for the labels, then the top 5 training examples from each predicted class could be added to the training dataset. Since the confidence scores for the top examples in an ‘easy’ predicted class are likely to be higher than the confidence scored for a ‘hard’ predicted class, there will likely be a number of non-selected training examples corresponding to the ‘easy’ predicted class whose confidence scores are higher than those of the selected training examples corresponding to the ‘hard’ predicted class.

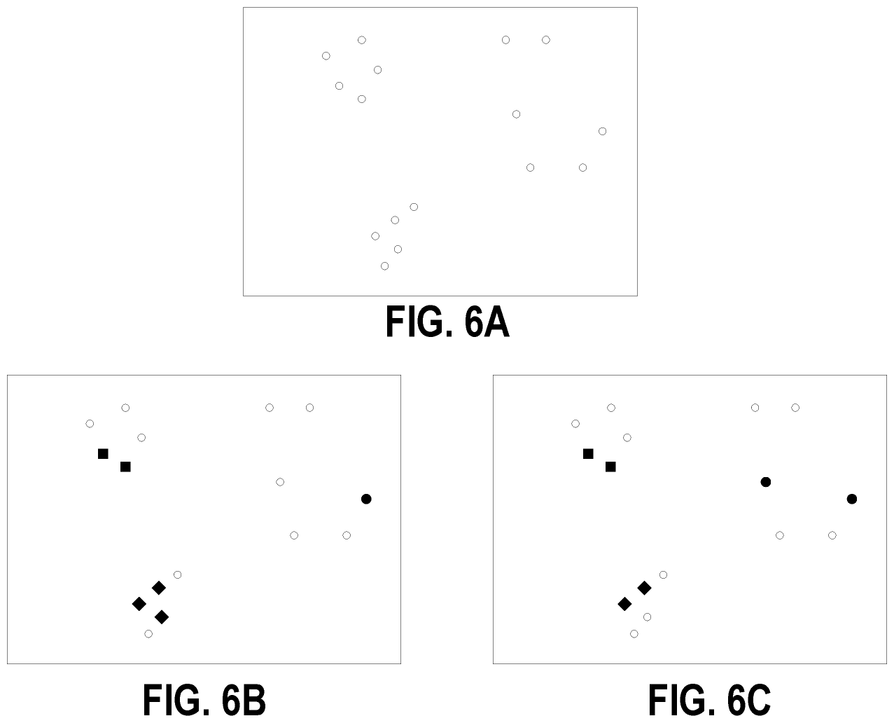

FIG. 6A illustrates a number of unlabeled training examples located within a two-dimensional embedding space. The unlabeled training examples are to be assigned to three different possible classes; accordingly, the unlabeled training examples are broadly grouped, within the embedding space, into three corresponding clusters (upper left, upper right, and lower center). A well-trained model would thus predict the same class for all of the unlabeled training examples in the same cluster. Each of the training examples could be applied to a model under training to generate therefor a respective predicted class and a confidence score for that predicted class. These confidence scores could then be used to determine which of the unlabeled training examples to add (labeled with their associated predicted labels) to the existing set of labeled training examples, to be used in further training the model.

As noted above, if the training examples are selected with regard only to the confidence score, without regard to the representation of the various predicted classes, then ‘easy’ classes may be over-represented. This is illustrated by way of example in FIG. 6B, where the predicted label of each selected training example is indicated by the shape of the training example (square for class 1, circle for class 2, and diamond for class 3). As illustrated in FIG. 6B, class 3 is the ‘easiest’ class, and half of the six selected training examples are predicted as belonging to class 3. Conversely, class 2 is the ‘hardest’ class, and only one of the six selected training examples are predicted as belonging to class 2. As a result, the training data used to further train the model will contain relatively fewer examples of this ‘hard’ class, and so the model is likely to only slowly improve with respect to predicting class 2.

Instead, balance amongst the possible classes could be enforced by selecting the top N examples, with respect to confidence score, from each of the possible classes. This is illustrated by way of example in FIG. 6C, where the predicted label of each selected training example is again indicated by the shape of the training example (square for class 1, circle for class 2, and diamond for class 3). As illustrated in FIG. 6C, the same number (two) of training examples are selected from each class. As a result, the same number of training examples from the ‘easy’ class 3 is added to the training dataset as is added from the ‘hard’ class 2. This more balanced training data, when used to further train the model, can cause the model improve more quickly with respect to predicting the ‘hard’ class 2.

Note that ‘balancing’ the set of selected unlabeled training examples across a set of predicted classes need not be limited to strictly selecting the same number of examples from each class, as illustrated in FIG. 6C. Instead, some other variety of balancing, to reduce the bias of the training dataset toward/against particular classes, could be employed. For example, the selected subset of unlabeled training examples could include at least a minimum number from each class, with the remainder of the subset selected with regard only to the confidence score. As an illustrative example, the top five training examples from each of eight classes could be selected, and then another twenty examples selected without regard to class, based only on confidence score, thus resulting in a slight bias toward the ‘easy’ classes, but still ensuring that the ‘hard’ classes receive at least a minimum level of representation.

The confidence score used to select the unlabeled training examples for addition to the labeled training dataset could be obtained in a variety of ways. In some examples, it could be a dedicated ‘confidence’ output of the model, separate from (or in addition to) a number of other outputs used to indicate the predicted class of an input or other information about the input. In another example, the output(s) of the model could be respectively probabilities or likelihoods that the input is a member of each possible class. In such an example, the predicted class of the input could be selected as the highest-probability/likelihood class, with the confidence score set equal to the probability/likelihood of the selected class. This is illustrated by way of example in Equation (1):

$$score ( {u}_{m} ) = {p}_{model} ( y \vert {x}_{m} ; θ )$$

where the “score” for a given training example uₘ is calculated as the probability p_{model} that the training example is a member of the selected class y given the information content of the training example xₘ (e.g., a sequence of tokens that represents the textual content of the training example) and the current parameter settings of the model θ. Additional or alternatively confidence scores could be determined from similar data, e.g., a difference between the probability/likelihood of the selected class and the highest-probability/likelihood non-selected class, a variance or other statistic across the predicted probabilities/likelihoods for the possible classes, or some other determination.

An additional or alternative method to generate confidence scores (in order to select the top N examples per class or in some other balanced fashion, or even without regard to balancing the selected training examples across the predicted classes) is to leverage the availability of an ‘embedding space’ into which the model under training may project inputs. Where such an embedding space is made available by the model, the locations of the unlabeled training examples in the embedding space, and their distance(s) within the embedding space to the locations of labeled training examples, can be used to determine confidence scores for the unlabeled training examples. This can be done such that higher confidence scores are assigned to unlabeled trained examples that are closer, in the embedding space, to labeled training examples that are labeled with the same class as that predicted for the unlabeled training example. Such training examples, being close in the embedding space to the labeled training examples, are more likely to be similar to those labeled examples and thus more likely to be correctly labeled with the same class as those nearby labeled training examples.

Vectors representing an input training example (either a labeled or an unlabeled training example) can be generated from a model in a variety of ways. In some examples, the vector could be an output of the model. For example, the model could be trained to output paragraph vectors, word vectors, or some other vector representation of inputs in a semantically-encoded (or otherwise representative) embedding space. This could include the model being an encoder trained as part of an auto-encoder, in which case the embedding space would the space of the latent variables output by the encoder (and received as inputs by the decoder). Additionally or alternatively, the vectors in the embedding space could be derived from intermediate variables of the model, e.g., from a set of outputs of units of a hidden layer of a multi-layer neural network of the model.

A variety of different metrics could be defined in the embedding space to generate distance(s) between the embedding vector of a particular unlabeled training example and the embedding vector(s) of one or more labeled training examples whose class matches the predicted class of the particular unlabeled training example. For example, an L1 distance, an L2 distance, a Minkowski distance, a cosine similarity, or some other distance or similarity metric could be used. For example, the distance between two embedding vectors could be determined as the cosine similarity defined in Equation (2):

$$cos ( {l}_{n} , {l}_{m} ) = \frac{{l}_{n} \cdot {l}_{m}}{‖ {l}_{n} ‖ \cdot ‖ {l}_{m} ‖}$$

where Iₙ and Iₘ are the embedding vectors. Where a distance-type metric is used (i.e., a metric that increases as similarity or proximity between the two embedding vectors decreases), the reciprocal of the distance could be used to compare the training examples for selection (e.g., such that higher reciprocal distance scores mean greater confidence, and thus are more likely to be selected). Alternatively, the training examples could be selected according to the lowest score with respect to distance.

The distance metric used to determine the confidence score for a particular unlabeled training example could be based on the distance to a single closest labeled example in the embedding space, or based on a combination of the distances to a number of labeled examples in the embedding space. The distances from the embedding vector of the particular unlabeled training example to the embedding vectors of each labeled training example of the same class as the predicted class could be calculated and then the closest distance, a set of closest distances (e.g., the three closest distances), some other subset of the distances, or all of the distances could be used to generate an overall ‘distance’ for the particular unlabeled training example (e.g., as an arithmetic mean, geometric, mean, or some other average or combination of a set of distances). This overall distance can then be used, on its own or in combination with some other information (e.g., a probability/likelihood of the predicted class of the particular unlabeled training example as output by the model), to determine a confidence score for the particular unlabeled training example.

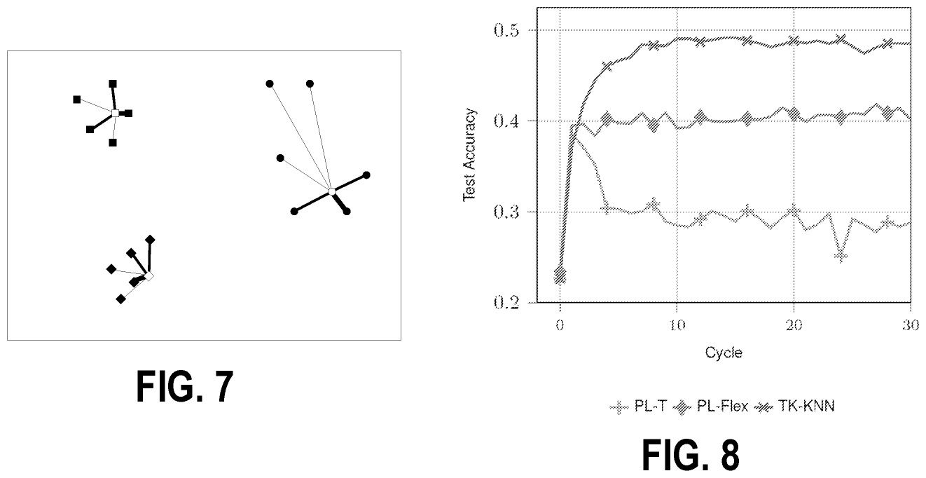

FIG. 7 depicts the locations and predicted classes (depicted by the different shapes) of three unlabeled training examples (the open circle, square, and diamond) in an embedding space. FIG. 7 also depicts the locations, in the embedding space, of a number of labeled training examples (filled circles, squares, and diamonds, with classes indicated by shape). Such labeled training examples could be manually-labeled training examples, or previously unlabeled training examples that were selected for addition to a labeled training dataset, being labeled within that labeled training dataset following their addition according to their model-predicted classes.

The distances between each unlabeled training example and the labeled training examples of the corresponding class are indicated in FIG. 7 by lines. In some examples, the overall distance determined for a particular unlabeled training example could be a combination (e.g., an average) of all of the distances, or a subset of the closest M distances (e.g., the closest three distances, indicated in FIG. 7 by the bolded lines). Alternatively, the distance for a particular unlabeled training example could be the distance to the closest labeled training examples of the same class (indicated in FIG. 7 by the thickest bolded lines).

As noted briefly above, the confidence score for an unlabeled training example could be a combination (e.g., a weighted combination) of a probability/likelihood of the predicted class for the training example and a distance metric determined between the location of the embedding vector of the training example and the embedding vector(s) of one or more labeled training examples of the same class in the embedding space. For example, the overall confidence score for a particular unlabeled training example could be a weighted combination of the probability of the predicted class of the training example and the cosine similarity of the embedding vector of the training example and the embedding vector of the embedding vector of the closest labeled training example, as in Equation (3):

$$score ( {u}_{m} ) = ( 1 - β ) * {p}_{model} ( y \vert {x}_{m} ; θ ) + β * sin ( {l}_{n} , {l}_{m} )$$

Here, β is a parameter determining the degree to which the weighted combination is weighted toward the cosine similarity, and the rest of the symbols are as in Equations (1) and (2) above. β could be fitted as a parameter during model fitting. Additionally or alternatively, B could be a hyperparameter determined once (e.g., during an extensive assessment of the methods described herein with respect to a particular set of training data, model architecture, or intended application) and then used at the determined level for subsequent model training. For example, β could be set between 0.6 and 0.85 (e.g., between 0.7 and 0.8, or to 0.75), favoring the distance metric (e.g., the cosine similarity to the closest labeled training example) over the probability/likelihood of the predicted class.

### A. Experimental Assessment

The embodiments described herein were experimentally assessed. Three well-known benchmark datasets were used to test and compare the embodiments described herein (which may be referred to as “TK-KNN” models, for “top-K k-nearest-neighbors”) against other models on the intent classification task. The intent classification datasets used were CLINC150 that contains 150 in-domain intent classes from ten different domains and one out-of-domain class. BANKING77 contains 77 intents, all related to the banking domain. HWU64 includes 64 intents coming from 21 different domains. Banking77 and Hwu64 do not provide validation sets, so validation sets were created from the original training sets. All datasets were in English. A breakdown of each dataset is shown in Table 1.

TABLE 1

| Dataset | Intents | Domain | Train | Val | Test |
|---|---|---|---|---|---|
| CLINC150 | 151 | 10 | 15,250 | 3,100 | 5,550 |
| Banking77 | 77 | 1 | 9,002 | 1,001 | 3,080 |
| Hwu64 | 64 | 21 | 8,884 | 1,076 | 1,076 |

Experiments were conducted with varying amounts of labeled data for each dataset. All methods were run with five random seeds and the mean average of their results were reported. This methodology permits tests of statistical significance. Reported results are thus accompanied by 95% confidence intervals.

### B. Baselines

To perform a thorough comparison of TK-KNN with existing methods, the following models and training strategies were assessed:
Supervised: only the labeled portion of the training dataset was used to train the model without any semi-supervised training. This model constitutes a competitive lower bound of performance because of the limits in the amount of labeled data.
Pseudo Labeling (PL): This strategy trains the model to convergence then makes predictions on all of the unlabeled data examples. These examples are then combined with the labeled data and used to re-train the model in an iterative manner.
Pseudo Labeling with Threshold (PL-T): This process follows the pseudo-labeling strategy but only selects unlabeled data elements which are predicted above a threshold t. A value for t of 0.95 was used based on the findings from previous work.
Pseudo Labeling with Flexmatch (PL-Flex): Rather than using a static threshold across all classes, a dynamic threshold is used for each class based on a curriculum learning framework.
GAN-BERT: This method applies generative adversarial networks to a pre-trained BERT model. The generator is an MLP that takes in a noise vector. The output head added to the BERT model acts as the discriminator and includes an extra class for predicting whether a given data element is real or not.
Mix Text: This method extends the MixUp framework to NLP and uses the hidden representation of BERT to mix together. The method also takes advantage of consistency regularization in the form of back translated examples.
TK-KNN: The method described herein, using top-k sampling with a weighted selection based on model predictions and cosine similarity to the labeled samples.
Top-k Upper: Top-k sampling method, but always selecting the correct pseudo-label. This model serves as an upper bound.

TABLE 2
Mean test accuracy results and their 95% confidence intervals across
5 repetitions with different random seeds. All experiments used k ± 6
and β ± 0.75. TK-KNN outperformed other models, especially
when the label set was small. The confidence interval also
shows that the TK-KNN results were stable across repetitions.

| | Percent Labeled | | | |
|---|---|---|---|---|
| Method | 1% | 2% | 5% | 10% |
| | CLINC150 | | | |
| Supervised | 27.35 ± 1.71 | 49.15 ± 1.90 | 67.96 ± 0.85 | 75.05 ± 1.67 |
| PL | 24.51 ± 3.92 | 48.58 ± 1.79 | 69.19 ± 0.54 | 76.92 ± 1.05 |
| PL-T | 39.05 ± 3.26 | 56.65 ± 1.53 | 71.25 ± 0.6 | 79.29 ± 1.62 |
| PL-Flex | 42.81 ± 4.39 | 60.07 ± 1.42 | 73.42 ± 1.62 | 78.86 ± 1.01 |
| GAN-BERT | 18.18 ± 0.0 | 23.29 ± 11.42 | 44,89 ± 24.39 | 63.02 ± 25.1 |
| Mix Text | 12.86 ± 6.39 | 37.93 ± 16.8 | 61.39 ± 0.77 | 74.29 ± 0.37 |
| TK-KNN (Ours) | 53.73 ± 1.72 | 65.87 ± 1.18 | 74.31 ± 0.96 | 79.45 ± 1.01 |
| | BANKING77 | | | |
| Supervised | 34.73 ± 1.5 | 47.51 ± 2.89 | 70.27 ± 1.08 | 80.82 ± 0.41 |
| PL | 29.09 ± 3.83 | 45.16 ± 2.71 | 69.69 ± 2.16 | 80.26 ± 0.49 |
| PL-T | 35.12 ± 3.80 | 51.67 ± 3.14 | 71.16 ± 1.98 | 81.88 ± 0.43 |
| PL-Flex | 40.04 ± 3.4 | 54.18 ± 3.31 | 73.43 ± 1.55 | 82.54 ± 0.84 |
| GAN-BERT | 5.4 ± 9.16 | 16.98 ± 21.73 | 54.09 ± 29.66 | 79.64 ± 1.39 |
| MixText | 32.73 ± 6.02 | 54.75 ± 3.15 | 76.59 ± 1.06 | 82.34 ± 0.94 |
| TK-KNN (Ours) | 54.16 ± 4.68 | 62.71 ± 2.30 | 76.73 ± 01.46 | 84.45 ± 0.52 |
| | HWU64 | | | |
| Supervised | 48.87 ± 1.55 | 63.88 ± 1.6 | 74.67 ± 1.91 | 82.21 ± 1.72 |
| PL | 48.46 ± 1.86 | 64.39 ± 1.66 | 75.76 ± 1.69 | 82.49 ± 0.94 |
| PL-T | 56.9 ± 1.64 | 68.29 ± 1.79 | 76.9 ± 1.1 | 82.96 ± 1.69 |
| PL-Flex | 60.15 ± 3.27 | 69.87 ± 0.93 | 77.99 ± 1.4 | 83.83 ± 1.2 |
| GAN-BERT | 33.36 ± 16.55 | 32.9 ± 29.07 | 72.32 ± 1.41 | 81.78 ± 1.64 |
| Mix Text | 33.3 ± 8.98 | 56.46 ± 11.08 | 66.65 ± 7.28 | 79.72 ± 1.27 |
| TK-KNN (Ours) | 65.33 ± 2.29 | 73.03 ± 1.31 | 79.63 ± 0.56 | 84.59 ± 0.58 |

### C. Implementation Details

Each method used the BERT base model with a classification head attached. The base BERT implementation provided by Huggingface that contains a total of 110M parameters was used. All models were trained for 30 cycles of self-training. The models were optimized with the AdamW optimizer with a learning rate of 5e-5. Each model was trained until convergence by early stopping applied according to the validation set. A batch size of 256 was used across experiments and the sequence length was limited to 64 tokens. For TK-KNN, k=6 and β=0.75 and the results were reported for these settings. An ablation study of these two hyperparameters is presented below.

In total it was estimated that around 14,000 GPU hours were used for this work. For the final experiments and ablation studies it was estimated that the TK-KNN model used 2400 GPU hours. Experiments were carried out on Nvidia Tesla P100 GPUs that each had 12 GB of memory.

### D. Results

Results from these experiments are shown in Table 2. These quantitative results demonstrate that TK-KNN yielded the best performance on the benchmark datasets. We observed the most significant performance gains for CLINC150 and BANKING77, where these datasets have more classes. For instance, on the CLINC150 dataset with 1% labeled data, our method performs 10.92% better than the second best strategy, FlexMatch. As the portion of labeled data used increases, we notice that the effectiveness of TK-KNN diminishes.

Another observation from these results is that the GAN-BERT model tends to be unstable when the labeled data is limited. This causes the model to have much larger confidence interval than other methods. However, GAN-BERT did improve as the proportion of labeled data increased. We also find that while the MixText method shows improvements the benefits of consistency regularization are not as strong compared to works from the computer vision domain

These results demonstrate the benefits of TK-KNN's balanced sampling strategy and its use of the distances in the latent space.

### E. Overconfidence in Pseudo-Labelling Regimes

A key observation throughout the self-training was that the performance of existing pseudo-labelling methods tended to degrade as the number of cycles increased. An example of this is illustrated in FIG. 8. When a pre-defined threshold was used, the model tended to improve performance for the first few training cycles. After that point, the pseudo-labeling became heavily biased towards the easier classes. This caused the model to become overconfident in predictions for those classes and to neglect more ‘difficult’ classes. PL-Flex corrected this issue but converged much earlier in the learning process. TK-KNN achieved the best performance thanks to the slower balanced pseudo-labeling approach. This process helped the model learn clearer decision boundaries for all classes simultaneously and prevented overconfidence in the model in some classes.

FIG. 8 depicts the results of a convergence analysis of pseudo-labelling strategies on CLINC150 at 1% labeled data. TK-KNN clearly outperformed the other pseudo-labelling strategies by balancing class pseudo labels after each training cycle.

### F. Ablation Study

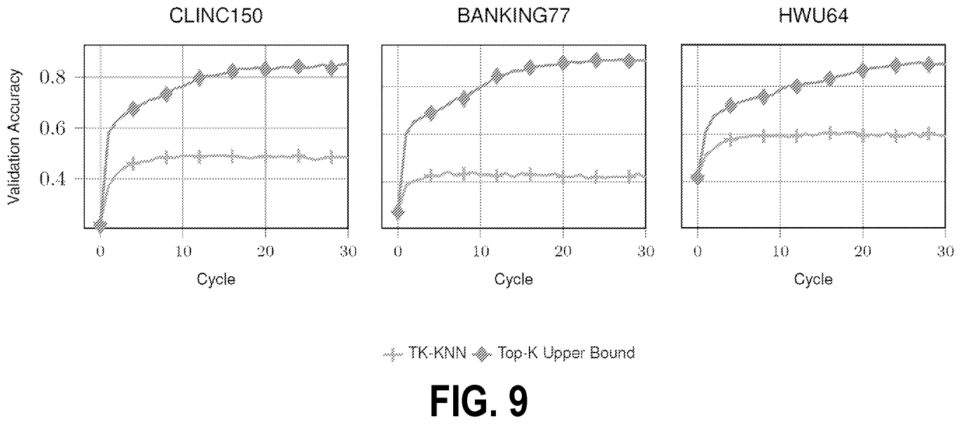

FIG. 9 depicts ablation study results for each dataset using 1% labeled data.

The embodiments described herein (e.g., the “TK-KNN” model) differs from prior methods in at least two ways: (1) top-k balanced sampling and (2) latent-space distance (“KNN”) ranking. Accordingly, a set of ablation experiments were performed to better understand how each of these affects performance. Specifically, TK-KNN was tested under three scenarios, top-k sampling without balancing the classes, top-k sampling with balanced classes, and top-k KNN without balancing for classes. When top-k sampling was performed in an unbalanced manner, the total data sampled was maintained equal to k*C, where C is the number of classes. The mean test accuracy results and their 95% confidence intervals are reported for these experiments in Table 3.

TABLE 3
Ablation study of top-k sampling. U stands for unbalanced sampling,
where classes are not balanced. B is for balanced sampling,
and classes are balanced with the top-k per class.

Percent Labeled

| | | |
|---|---|---|
| Method | 1% | 2% |

CLINC150

| | | |
|---|---|---|
| Top-k U | 38.37 ± 1.08 | 55.0 ± 1.44 |
| Top-k B | 51.36 ± 2.1 | 64.99 ± 0.64 |
| Top-k KNN U | 41.24 ± 0.97 | 55.01 ± 1.40 |
| Top-k KNN B | 53.73 ± 1.72 | 65.87 ± 1.18 |

BANKING77

| | | |
|---|---|---|
| Top-k U | 41.56 ± 4.73 | 54.78 ± 3.51 |
| Top-k B | 50.45 ± 4.53 | 63.19 ± 1.78 |
| Top-k KNN U | 44.12 ± 3.14 | 55.9 ± 2.85 |
| Top-k KNN B | 54.16 ± 4.56 | 62.71 ± 2.30 |

HWU64

| | | |
|---|---|---|
| Top-k U | 54.87 ± 1.64 | 64.85 ± 1.54 |
| Top-k B | 54.13 ± 6.0 | 65.12 ± 0.36 |
| Top-k KNN U | 57.86 ± 2.25 | 69.33 ± 0.96 |
| Top-k KNN B | 65.33 ± 2.29 | 73.03 ± 1.31 |

The results from the ablation study demonstrate both the effectiveness of top-k sampling and KNN ranking. A comparison between the unbalanced sampling, top-k sampling, and balanced versions shows a drastic difference in performance across all datasets. The performance difference was greatest in the lowest resource setting, with a 12.47% increase in accuracy for CLINC150 in the 1% setting.

Results from the TK-KNN method with unbalanced sampling also showed an improvement over unbalanced sampling alone. This increase in performance was smaller than the difference between unbalanced and balanced sampling but still highlights the benefits of leveraging the geometry for selective pseudo-labeling.

### G. Upper Bound Analysis

Further experiments were preformed to gauge the performance of top-k sampling when ground truth labels were fed to the model instead of predicted pseudo-labels. This experiment provides an indication as to how performance might increase throughout the self-training process in an ideal pseudo-labeling scenario. The results of this analysis are provided in FIG. 9.

As expected, the model tended to converge towards a fully supervised performance as the cycle increased and more data was (pseudo-) labeled. Another point of interest is that the method's upper bound can continue learning with proper labels, while TK-KNN method tended to converge earlier. The upper bound method also exhibited a significant increase in the first few cycles as well.

### H. Parameter Search

The TK-KNN or other embodiments described herein may rely on one or both of the hyperparameters k and β. These hyperparameters can affect performance based on how they are configured. Experiments were performed to gauge their effect on learning by testing k=(4, 6, 8) and β=(0.0, 0.75, 1.00). When varying k, β was held at 0.75. For β experiments k was held at 6. When β=0.0, this is equivalent to just top-k sampling. Alternatively, when β=1.0, this is equivalent to only using the latent-space distance similarity (e.g., cosine similarity) for ranking.

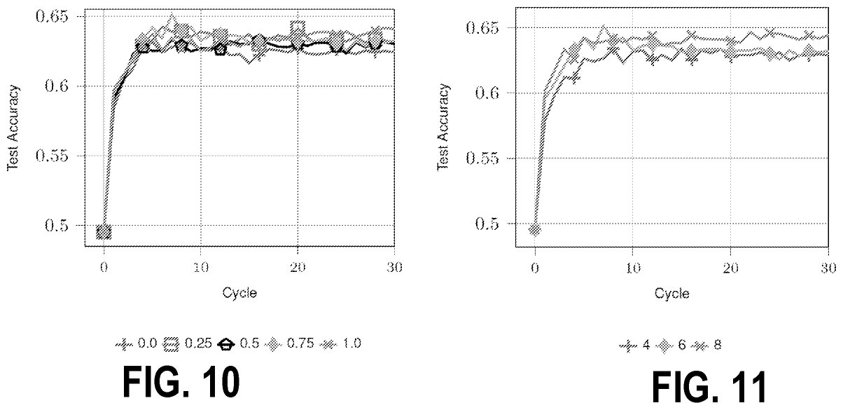

Multiple values of k were evaluated, with values of (4,6,8). Changing the value of k does affect model performance to some extent. Results from these experiments are shown in FIGS. 10 and 11.

FIG. 10 shows a comparison of TK-KNN on HWU64 with 1% labeled data as β varies.

FIG. 11 shows a comparison of TK-KNN on HWU64 with 1% labeled data as k varies.

As the β parameter was varied, all configurations tended to have similar training patterns. After the model was trained for the first five cycles, the model tended to move in small jumps between subsequent cycles. As shown in the figures, no single method was always the best, but the model tended to perform worse when β=0.0. The model reached the best performance when β=0.75, which occurred about halfway through the training process. Comparison of values for k show more consistent performance for k=6 than the other two settings. Throughout almost the entire training process, k=6 resulted in better performance. When a larger k was used, this sometimes lead to too many bad examples being included in the training process early on, which resulted in worse performance.

### VII. Example Operations

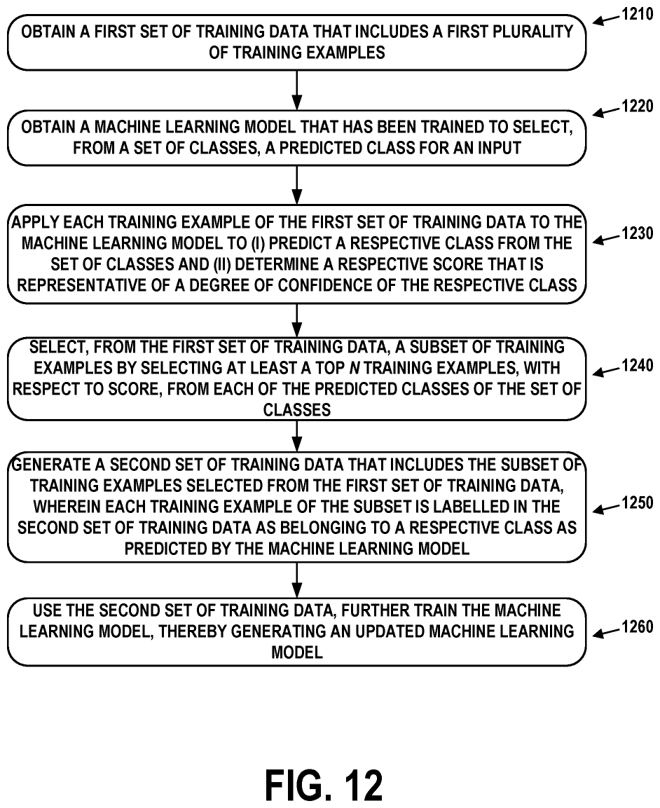

FIG. 12 is a flow chart illustrating an example embodiment. The process illustrated by FIG. 12 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 12 may be simplified by the removal of any one or more of the features shown therein. Further, these embodiments may be combined with features, aspects, and/or implementations of any of the previous figures or otherwise described herein.

The example embodiment of FIG. 12 includes obtaining a first set of training data that includes a first plurality of training examples (1210). The example embodiment of FIG. 12 additionally includes obtaining a machine learning model that has been trained to select, from a set of classes, a predicted class for an input (1220). The example embodiment of FIG. 12 additionally includes applying each training example of the first set of training data to the machine learning model to (i) predict a respective class from the set of classes and (ii) determine a respective score that is representative of a degree of confidence of the respective class (1230). The example embodiment of FIG. 12 additionally includes selecting, from the first set of training data, a subset of training examples by selecting at least a top N training examples, with respect to score, from each of the predicted classes of the set of classes (1240). The example embodiment of FIG. 12 additionally includes generating a second set of training data that includes the subset of training examples selected from the first set of training data, wherein each training example of the subset is labelled in the second set of training data as belonging to a respective class as predicted by the machine learning model (1250). The example embodiment of FIG. 12 additionally includes, using the second set of training data, further training the machine learning model, thereby generating an updated machine learning model (1260). The example embodiment of FIG. 12 may include additional or alternative features.

In some embodiments, each training example in the first plurality of training examples represents a textual input, wherein each class of the set of classes represents a respective different type of response that could be expressed in a textual input.

In some embodiments, determining the respective score comprises generating, as an output of the machine learning model when applying the given training example thereto, at least one of a likelihood or a probability that the given training example is a member of a predicted class of the given training example.

Some embodiments may further involve: prior to applying each training example of the first set of training data to the machine learning model: (i) obtaining a third set of training data that includes a third plurality of training examples, wherein each training example of the third set of training data is labelled as belonging to a respective class selected from the set of classes, and (ii) using the third set of training data, training the machine learning model to select, from the set of classes, a predicted class for an input, wherein generating the second set of training data comprises adding, to the first set of training data, the subset of training examples selected from the first set of training data, wherein applying each training example of the first set of training data to the machine learning model additionally comprises generating a respective embedding vector that represents a respective location in an embedding space.

These embodiments may additionally include: applying each training example of the third set of training data to the machine learning model to generate a respective embedding vector that represents a respective location in the embedding space; and determining, for the given training example, at least one distance between an embedding vector output by the machine learning model when applying the given training example thereto and at least one embedding vector generated for a respective at least one training example of the third set of training data that is of a common class as the predicted class of the given training example, and wherein determining, for the given training example of the first set of training data, a score that is representative of the degree of confidence of a class of the given training example comprises determining a weighted combination of (i) the at least one distance and (ii) the at least one of a likelihood or a probability that the given training example is a member of a predicted class of the given training example.

In some embodiments, determining the at least one distance comprises determining at least one cosine similarity between the embedding vector output by the machine learning model when applying the given training example thereto and the at least one embedding vector generated for the respective at least one training example of the third set of training data that is of the common class as the predicted class of the given training example.

In some embodiments, determining the at least one distance comprises determining a distance between the embedding vector output by the machine learning model when applying the given training example thereto and an embedding vector generated for a training example of the third set of training data that is, of the training examples of the third set of training data that are the common class as the predicted class of the given training example, closest in the embedding space.

In some embodiments, wherein determining the weighted combination comprises determining a combination that weighted between 0.6 and 0.85 toward the at least one distance.

In some embodiments, the machine learning model comprises a transformer.

Some embodiments may further involve: prior to applying each training example of the first set of training data to the machine learning model: (i) obtaining a third set of training data that includes a third plurality of training examples, wherein each training example of the third set of training data is labelled as belonging to a respective class selected from the set of classes, and (ii) using the third set of training data, training the machine learning model to select, from the set of classes, a predicted class for an input, wherein generating the second set of training data comprises adding, to the first set of training data, the subset of training examples selected from the first set of training data, wherein applying each training example of the first set of training data to the machine learning model additionally comprises generating a respective embedding vector that represents a respective location in an embedding space.

These embodiments may additionally involve: applying each training example of the third set of training data to the machine learning model to generate a respective embedding vector that represents a respective location in the embedding space; and determining, for the given training example, at least one distance between an embedding vector output by the machine learning model when applying the given training example thereto and at least one embedding vector generated for a respective at least one training example of the third set of training data that is of a common class as the predicted class of the given training example, and wherein determining a score that is representative of the degree of confidence of a class of the given training example comprises determining the score based on the at least one distance.

In some embodiments, determining the at least one distance comprises determining at least one cosine similarity between the embedding vector output by the machine learning model when applying the given training example thereto and the at least one embedding vector generated for the respective at least one training example of the third set of training data that is of the common class as the predicted class of the given training example.

In some embodiments, determining the at least one distance comprises determining a distance between the embedding vector output by the machine learning model when applying the given training example thereto and an embedding vector generated for a training example of the third set of training data that is, of the training examples of the third set of training data that are the common class as the predicted class of the given training example, closest in the embedding space.

### VIII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a first set of training data that includes a first plurality of training examples;
obtaining a machine learning model that has been trained to select, from a set of classes, a predicted class for an input;
applying each training example of the first set of training data to the machine learning model to (i) predict a respective class from the set of classes and (ii) determine a respective score that is representative of a degree of confidence of the respective class;
selecting, from the first set of training data, a subset of training examples by selecting at least a top N training examples, with respect to score, from each of the predicted classes of the set of classes;
generating a second set of training data that includes the subset of training examples selected from the first set of training data, wherein each training example of the subset is labelled in the second set of training data as belonging to a respective class as predicted by the machine learning model; and
using the second set of training data, further training the machine learning model, thereby generating an updated machine learning model.

2. The method of claim 1, wherein each training example in the first plurality of training examples represents a textual input, and wherein each class of the set of classes represents a respective different type of response that could be expressed in a textual input.

3. The method of claim 1, wherein determining the respective score comprises generating, as an output of the machine learning model when applying the given training example thereto, at least one of a likelihood or a probability that the given training example is a member of a predicted class of the given training example.

4. The method of claim 3, further comprising, prior to applying each training example of the first set of training data to the machine learning model: (i) obtaining a third set of training data that includes a third plurality of training examples, wherein each training example of the third set of training data is labelled as belonging to a respective class selected from the set of classes, and (ii) using the third set of training data, training the machine learning model to select, from the set of classes, a predicted class for an input,
wherein generating the second set of training data comprises adding, to the first set of training data, the subset of training examples selected from the first set of training data,
wherein applying each training example of the first set of training data to the machine learning model additionally comprises generating a respective embedding vector that represents a respective location in an embedding space,
wherein the method yet further comprises:
applying each training example of the third set of training data to the machine learning model to generate a respective embedding vector that represents a respective location in the embedding space; and
determining, for the given training example, at least one distance between an embedding vector output by the machine learning model when applying the given training example thereto and at least one embedding vector generated for a respective at least one training example of the third set of training data that is of a common class as the predicted class of the given training example, and
wherein determining, for the given training example of the first set of training data, a score that is representative of the degree of confidence of a class of the given training example comprises determining a weighted combination of (i) the at least one distance and (ii) the at least one of a likelihood or a probability that the given training example is a member of a predicted class of the given training example.

5. The method of claim 4, wherein determining the at least one distance comprises determining at least one cosine similarity between the embedding vector output by the machine learning model when applying the given training example thereto and the at least one embedding vector generated for the respective at least one training example of the third set of training data that is of the common class as the predicted class of the given training example.

6. The method of claim 4, wherein determining the at least one distance comprises determining a distance between the embedding vector output by the machine learning model when applying the given training example thereto and an embedding vector generated for a training example of the third set of training data that is, of the training examples of the third set of training data that are the common class as the predicted class of the given training example, closest in the embedding space.

7. The method of claim 4, wherein determining the weighted combination comprises determining a combination that weighted between 0.6 and 0.85 toward the at least one distance.

8. The method of claim 1, wherein the machine learning model comprises a transformer.

9. The method of claim 1, further comprising, prior to applying each training example of the first set of training data to the machine learning model: (i) obtaining a third set of training data that includes a third plurality of training examples, wherein each training example of the third set of training data is labelled as belonging to a respective class selected from the set of classes, and (ii) using the third set of training data, training the machine learning model to select, from the set of classes, a predicted class for an input,
wherein generating the second set of training data comprises adding, to the first set of training data, the subset of training examples selected from the first set of training data,
wherein applying each training example of the first set of training data to the machine learning model additionally comprises generating a respective embedding vector that represents a respective location in an embedding space,
wherein the method yet further comprises:
applying each training example of the third set of training data to the machine learning model to generate a respective embedding vector that represents a respective location in the embedding space; and
determining, for the given training example, at least one distance between an embedding vector output by the machine learning model when applying the given training example thereto and at least one embedding vector generated for a respective at least one training example of the third set of training data that is of a common class as the predicted class of the given training example, and
wherein determining a score that is representative of the degree of confidence of a class of the given training example comprises determining the score based on the at least one distance.

10. The method of claim 9, wherein determining the at least one distance comprises determining at least one cosine similarity between the embedding vector output by the machine learning model when applying the given training example thereto and the at least one embedding vector generated for the respective at least one training example of the third set of training data that is of the common class as the predicted class of the given training example.

11. The method of claim 9, wherein determining the at least one distance comprises determining a distance between the embedding vector output by the machine learning model when applying the given training example thereto and an embedding vector generated for a training example of the third set of training data that is, of the training examples of the third set of training data that are the common class as the predicted class of the given training example, closest in the embedding space.

12. A non-transitory computer-readable medium, having stored thereon program instructions that, upon execution by a computing system, cause the computing system to perform operations comprising:
obtaining a first set of training data that includes a first plurality of training examples;
obtaining a machine learning model that has been trained to select, from a set of classes, a predicted class for an input;
applying each training example of the first set of training data to the machine learning model to (i) predict a respective class from the set of classes and (ii) determine a respective score that is representative of a degree of confidence of the respective class;
selecting, from the first set of training data, a subset of training examples by selecting at least a top N training examples, with respect to score, from each of the predicted classes of the set of classes;
generating a second set of training data that includes the subset of training examples selected from the first set of training data, wherein each training example of the subset is labelled in the second set of training data as belonging to a respective class as predicted by the machine learning model; and
using the second set of training data, further training the machine learning model, thereby generating an updated machine learning model.

13. The non-transitory computer-readable medium of claim 12, wherein determining the respective score comprises generating, as an output of the machine learning model when applying the given training example thereto, at least one of a likelihood or a probability that the given training example is a member of a predicted class of the given training example.

14. The non-transitory computer-readable medium of claim 13, wherein the operations further comprise, prior to applying each training example of the first set of training data to the machine learning model: (i) obtaining a third set of training data that includes a third plurality of training examples, wherein each training example of the third set of training data is labelled as belonging to a respective class selected from the set of classes, and (ii) using the third set of training data, training the machine learning model to select, from the set of classes, a predicted class for an input,
wherein generating the second set of training data comprises adding, to the first set of training data, the subset of training examples selected from the first set of training data,
wherein applying each training example of the first set of training data to the machine learning model additionally comprises generating a respective embedding vector that represents a respective location in an embedding space,
wherein the operations yet further comprise:
applying each training example of the third set of training data to the machine learning model to generate a respective embedding vector that represents a respective location in the embedding space; and
determining, for the given training example, at least one distance between an embedding vector output by the machine learning model when applying the given training example thereto and at least one embedding vector generated for a respective at least one training example of the third set of training data that is of a common class as the predicted class of the given training example, and
wherein determining, for the given training example of the first set of training data, a score that is representative of the degree of confidence of a class of the given training example comprises determining a weighted combination of (i) the at least one distance and (ii) the at least one of a likelihood or a probability that the given training example is a member of a predicted class of the given training example.

15. The non-transitory computer-readable medium of claim 14, wherein determining the at least one distance comprises determining at least one cosine similarity between the embedding vector output by the machine learning model when applying the given training example thereto and the at least one embedding vector generated for the respective at least one training example of the third set of training data that is of the common class as the predicted class of the given training example.

16. The non-transitory computer-readable medium of claim 12, wherein the machine learning model comprises a transformer.

17. A system comprising:
one or more processors; and
memory, containing program instructions that, upon execution by the one or more processors, cause the system to perform operations comprising:
obtaining a first set of training data that includes a first plurality of training examples;
obtaining a machine learning model that has been trained to select, from a set of classes, a predicted class for an input;
applying each training example of the first set of training data to the machine learning model to (i) predict a respective class from the set of classes and (ii) determine a respective score that is representative of a degree of confidence of the respective class;
selecting, from the first set of training data, a subset of training examples by selecting at least a top N training examples, with respect to score, from each of the predicted classes of the set of classes;
generating a second set of training data that includes the subset of training examples selected from the first set of training data, wherein each training example of the subset is labelled in the second set of training data as belonging to a respective class as predicted by the machine learning model; and
using the second set of training data, further training the machine learning model, thereby generating an updated machine learning model.

18. The system of claim 12, wherein determining the respective score comprises generating, as an output of the machine learning model when applying the given training example thereto, at least one of a likelihood or a probability that the given training example is a member of a predicted class of the given training example.

19. The system of claim 18, wherein the operations further comprise, prior to applying each training example of the first set of training data to the machine learning model: (i) obtaining a third set of training data that includes a third plurality of training examples, wherein each training example of the third set of training data is labelled as belonging to a respective class selected from the set of classes, and (ii) using the third set of training data, training the machine learning model to select, from the set of classes, a predicted class for an input,
wherein generating the second set of training data comprises adding, to the first set of training data, the subset of training examples selected from the first set of training data,
wherein applying each training example of the first set of training data to the machine learning model additionally comprises generating a respective embedding vector that represents a respective location in an embedding space,
wherein the operations yet further comprise:
applying each training example of the third set of training data to the machine learning model to generate a respective embedding vector that represents a respective location in the embedding space; and
determining, for the given training example, at least one distance between an embedding vector output by the machine learning model when applying the given training example thereto and at least one embedding vector generated for a respective at least one training example of the third set of training data that is of a common class as the predicted class of the given training example, and
wherein determining, for the given training example of the first set of training data, a score that is representative of the degree of confidence of a class of the given training example comprises determining a weighted combination of (i) the at least one distance and (ii) the at least one of a likelihood or a probability that the given training example is a member of a predicted class of the given training example.

20. The system of claim 19, wherein determining the at least one distance comprises determining at least one cosine similarity between the embedding vector output by the machine learning model when applying the given training example thereto and the at least one embedding vector generated for the respective at least one training example of the third set of training data that is of the common class as the predicted class of the given training example.
